(19) United States
(12) Patent Application Publication
(10) Pub. No.: US 2017/0101117 A1
(43) Pub. Date: Apr. 13, 2017

(54) UTILITY CART FRAME ASSEMBLY

(71) Applicant: Kramble Industries Inc, Saskatoon (CA)

(72) Inventors: Douglas James Kramble, Saskatoon (CA); Alan Reid, Tees (CA)

(21) Appl. No.: 14/881,999

(22) Filed: Oct. 13, 2015

(51) Int. Cl. B62B 3/00; B62B 5/00

(52) U.S. Cl. CPC B62B 3/007; B62B 5/0026; B62B 3/001; B62B 2501/06

(57) ABSTRACT

A frame for a utility cart, having a channel-shaped chassis with a load-bearing bed member forming an upper cover for the chassis. The chassis is preferably formed of a single sheet of metal, bent at primary bend lines to form side wall sections with a base section therebetween, and the side wall sections bent at secondary bend lines to form outwardly-extending lateral sections. The bed member is preferably bolted to the lateral sections to form a four-sided channel. Components for the transport assembly and steering assembly can be housed within this channel.

### FIELD OF THE INVENTION

The present invention relates to utility carts, and specifically to frame structures for utility carts.

### BACKGROUND OF THE INVENTION

Utility carts have become ubiquitous for the short-range transport of loads such as crates, boxes or bundles, for example in shops or warehouses. It is known in the art of utility cart design to provide a frame that will deliver adequate support for the loads intended to be borne on the upper surface of the cart. Where anticipated loads are of significant weight, reliance is placed on heavy-duty steel square tubing to supply the required structural strength. Lengths of steel tubing are welded together to form a support structure on which a load-bearing surface can be mounted, and drive and steering assemblies can be connected to the frame.

However, while welded square tube framing can provide the desired strength, the result can be an undesirably heavy frame and thus a reduced load capacity. This is also the case with motorized utility carts, where a significant amount of the drive unit capacity is spent simply on moving the heavy frame itself. By reducing the load capacity, the number of trips is increased, and depending on the per-unit weight certain loads simply cannot be hauled with the cart.

What is needed, therefore, is a utility cart design that maintains a desirable strength while reducing the weight of the cart itself.

### SUMMARY OF THE INVENTION

The present invention therefore seeks to provide a novel utility cart frame design, which seeks to reduce cart weight while providing a structure of adequate strength for load hauling.

According to a first broad aspect of the present invention, there is provided a frame assembly for a utility cart, the assembly comprising:

a chassis comprising:
a channel-shaped member comprising:
   a base section;
   a first side wall section connected to the base section and extending generally upwardly therefrom; and
   a second side wall section connected to the base section and extending generally upwardly therefrom, spaced from the first side wall section;
a first laterally-extending section connected to the first side wall section; and
a second laterally-extending section connected to the second side wall section; and
   a bed member configured for attachment to upper surfaces of the first and second laterally-extending sections of the chassis.

The chassis and the bed member are preferably composed of steel but could be composed of aluminum. The chassis is preferably configured for connection to both a drive unit to enable movement of the utility cart across a surface, and a steering unit to enable directional steering of the utility cart.

In exemplary embodiments of the first aspect, the base section, the first and second side wall sections, and the bed member when attached to the first and second laterally-extending sections form an open-ended, four-sided channel. This can form an interior space sized for receipt of motorization components to enable motorization of the utility cart.

The bed member is preferably configured for attachment to the upper surfaces of the first and second laterally-extending sections by means of bolting. While each of the first and second side wall sections may be generally normal to the base section, they may alternatively be at a non-right angle to the base section. The first and second laterally-extending sections are preferably generally parallel to the base section.

In some embodiments, edges of the bed member are bent over to increase stiffness of the bed member, and it may be desirable to provide at least one bracket connecting each of the first and second side wall sections to the base section.

As is the case with the exemplary embodiment described herein, in some embodiments the base section, the first and second side wall sections, and the first and second laterally-extending sections are of unitary construction.

According to a second broad aspect of the present invention, there is provided a frame for a utility cart, the frame comprising:

a chassis comprising:
a base section having opposed first and second edges;
first and second side wall sections connected to the first and second edges, respectively; and
first and second laterally-extending sections connected to upper edges of the first and second side wall sections, respectively;
the base section, first and second side wall sections, and first and second laterally-extending sections of unitary construction;

and

a load-bearing bed member mounted on upper surfaces of the first and second laterally-extending sections;

the chassis configured for connection to transport members.

The chassis and the bed member are preferably composed of steel but could be composed of aluminum. The transport members preferably comprise at least two wheels, and most preferably four, to enable movement of the utility cart across a surface. The chassis is also preferably configured for connection to a steering unit to enable directional steering of the utility cart.

In exemplary embodiments of the second aspect, the base section, the first and second side wall sections, and the bed member form an open-ended, four-sided channel. This can provide an interior space sized for receipt of motorization components to enable motorization of the utility cart.

The bed member is preferably mounted on the upper surfaces of the first and second laterally-extending sections by means of bolting. While each of the first and second side wall sections may be generally normal to the base section, they may alternatively be at a non-right angle to the base section. The first and second laterally-extending sections are preferably generally parallel to the base section.

In some embodiments, edges of the bed member are bent over to increase stiffness of the bed member, and it may be desirable to provide at least one bracket connecting each of the first and second side wall sections to the base section.

According to a third broad aspect of the present invention, there is provided a utility cart comprising:

a frame assembly comprising:
a chassis comprising:
   a base section having opposed first and second edges;
   first and second side wall sections connected to the first and second edges, respectively; and
   first and second laterally-extending sections connected to upper edges of the first and second side wall sections, respectively;
   the base section, first and second side wall sections, and first and second laterally-extending sections of unitary construction;
and
a load-bearing bed member mounted on upper surfaces of the first and second laterally-extending sections;

a transport assembly operably connected to the frame assembly to enable movement of the utility cart across a surface; and

a steering assembly operably connected to the frame assembly to enable directional steering of the utility cart.

The chassis and the bed member are preferably composed of steel but could be composed of aluminum.

The transport assembly preferably comprises at least two wheels, and most preferably four, to enable movement of the utility cart across a surface. The transport assembly preferably further comprises a drive unit to power the at least two wheels.

The steering assembly preferably comprises a handle to enable directional steering of the utility cart. Where the transport assembly comprises at least two wheels and a drive unit to power the at least two wheels, the handle preferably comprises manually operable controls for controlling the drive unit.

In exemplary embodiments of the third aspect, the base section, the first and second side wall sections, and the bed member form an open-ended, four-sided channel. This can provide an interior space sized for receipt of components of the transport assembly and the steering assembly.

The bed member is preferably mounted on the upper surfaces of the first and second laterally-extending sections by means of bolting. While each of the first and second side wall sections may be generally normal to the base section, they may alternatively be at a non-right angle to the base section. The first and second laterally-extending sections are preferably generally parallel to the base section.

In some embodiments, edges of the bed member are bent over to increase stiffness of the bed member, and it may be desirable to provide at least one bracket connecting each of the first and second side wall sections to the base section.

According to a fourth broad aspect of the present invention, there is provided a method for manufacturing a frame for a utility cart, the method comprising the steps of:

providing a first rigid sheet;
bending the first rigid sheet at two spaced-apart primary bend lines to form first and second upwardly-extending side wall sections and a generally horizontal base section therebetween;
bending each of the first and second upwardly-extending side wall sections at secondary bend lines to form first and second outwardly-extending lateral sections, respectively;
providing a second rigid sheet; and
connecting the second rigid sheet to upper surfaces of the first and second outwardly-extending lateral sections.

The first rigid sheet and the second rigid sheet are preferably composed of steel but could be composed of aluminum.

In some exemplary embodiments, the placement of the primary bend lines is selected such that the first and second side wall sections are of generally equal height after the step of bending the first rigid sheet at the primary bend lines to form the first and second side wall sections.

Subsequently, the placement of the secondary bend lines is preferably selected such that the first and second side wall sections are of generally equal height after the step of bending the first and second side wall sections at the secondary bend lines to form the first and second lateral sections.

The step of connecting the second rigid sheet to the upper surfaces of the first and second lateral sections preferably forms an open-ended, four-sided channel with the base section and the first and second side wall sections, which can provide an interior space sized for receipt of motorization components to enable motorization of the utility cart.

The second rigid sheet is preferably connected to the upper surfaces of the first and second lateral sections by means of bolting. Where this is the case, some exemplary embodiments comprise the further step after providing the first and second rigid sheets of forming apertures in the first and second rigid sheets to enable the bolting of the second rigid sheet to the first and second lateral sections.

In some exemplary methods, the step of bending the first rigid sheet at the primary bend lines forms the first and second side wall sections normal to the base section. However, the step of bending the first rigid sheet at the primary bend lines could alternatively form the first and second side wall sections at a non-right angle to the base section. The step of bending the first and second side wall sections at the secondary bend lines preferably forms the first and second lateral sections generally parallel to the base section.

Some exemplary methods comprise the further step after providing the second rigid sheet of bending edges of the second rigid sheet to increase stiffness of the second rigid sheet. In addition, the further step may be incorporated of using at least one bracket to connect each of the first and second side wall sections to the base section.

A detailed description of an exemplary embodiment of the present invention is given in the following. It is to be understood, however, that the invention is not to be construed as being limited to this embodiment. The exemplary embodiment is directed to a particular application of the present invention, while it will be clear to those skilled in the art that the present invention has applicability beyond the exemplary embodiment set forth herein.

### BRIEF DESCRIPTION OF THE DRAWINGS

In the accompanying drawings, which illustrate an exemplary embodiment of the present invention:

FIG. 1a is a top plan view of an exemplary chassis according to the present invention;

FIG. 1b is a side elevation view of the chassis of FIG. 1a;

FIG. 1c is a top perspective view of the chassis of FIG. 1a;

FIG. 1d is a bottom perspective view of the chassis of FIG. 1a;

FIG. 1e is an end elevation view of the chassis of FIG. 1a;

FIG. 2a is a top plan view of an exemplary bed member according to the present invention;

FIG. 2b is a side elevation view of the bed member of FIG. 2a;

FIG. 2c is a top perspective view of the bed member of FIG. 2a;

FIG. 2d is a bottom perspective view of the bed member of FIG. 2a;

FIG. 2e is an end elevation view of the bed member of FIG. 2a;

FIG. 3a is a sectional view of an exemplary bed member bolted to an exemplary chassis according to the present invention;

FIG. 3b is a top plan view of the bed member and chassis of FIG. 3a;

FIG. 3c is a side elevation view of the bed member and chassis of FIG. 3a;

FIG. 3d is an exploded perspective view of the bed member and chassis of FIG. 3a;

FIG. 3e is an end elevation view of the bed member and chassis of FIG. 3a;

FIG. 3f is a top perspective view of the bed member and chassis of FIG. 3a;

FIG. 3g is a bottom perspective view of the bed member and chassis of FIG. 3a;

FIG. 4a is a top plan view of an exemplary bed member and chassis with components housed in the interior space;

FIG. 4b is a side elevation view of the bed member and chassis of FIG. 4a;

FIG. 4c is a top plan view of the bed member only of FIG. 4a, showing the components housed in the interior space;

FIG. 4d is an end elevation view of the bed member and chassis of FIG. 4a;

FIG. 5a is a top plan view of an exemplary utility cart according to the present invention;

FIG. 5b is a side elevation view of the cart of FIG. 5a;

FIG. 5c is an end elevation view of the cart of FIG. 5a; and

FIG. 5d is a perspective view of the cart of FIG. 5a.

An exemplary embodiment of the present invention will now be described with reference to the accompanying drawings.

### DETAILED DESCRIPTION OF EXEMPLARY EMBODIMENT

Throughout the following description specific details are set forth in order to provide a more thorough understanding to persons skilled in the art. However, well known elements may not have been shown or described in detail to avoid unnecessarily obscuring the disclosure. The following description of an example of the technology is not intended to be exhaustive or to limit the invention to the precise form of the exemplary embodiment. Accordingly, the description and drawings are to be regarded in an illustrative, rather than a restrictive, sense.

The present invention is directed to a novel utility cart design, and specifically a design that incorporates a channel-like chassis rather than the conventional steel tubing-based structure. While conventional wisdom holds that a heavy-duty, bulky square tubing frame provides a superior load-bearing capacity, it has been surprisingly found that a channel-like chassis formed from bent metal plate can provide improved load-bearing capacity compared to conventional cart frame structures.

In determining the respective bending capacity or strength of a bent steel chassis as opposed to a steel tubing frame, the section modulus is calculated for each based on the cross-sectional area of a piece of the support steel. The section modulus is determined by use of the following equation:

S=Bh³/6H

where S is the section modulus in cubic inches

B is the outside width of the base in inches

h is the inside height of the side in inches

H is the outside height of the side in inches

Assuming a 2 in² steel tube with a ⅛ inch wall thickness:

S=Bh³/6H

S=2×1.75 3/6×2

S=0.9 in³

Assuming the conventional use of two tubes, the total section modulus would be 1.8 in³.

For a bent steel chassis, assume a closed tube 8.29 inches in height and 8.52 inches in width (outside dimensions), using 0.12 inch steel plate:

S=Bh³/6H

S=8.52×8.05 3/6×8.29

S=89.4 in³

Surprisingly, it was thus found that the use of a bent steel chassis in the above form provides a substantial increase in bending load capacity, roughly on the order of 50 times the bending load (89.4/1.8), but using the same base material (steel). Given the substantial improvement in load bearing capacity, the plate can actually be made even thinner while retaining a significant improvement over the conventional steel tubing frame structure, thus reducing cost and overall weight.

To check the fine point load that can be carried at the middle of a cart (least desirable load positioning) based on the bent steel chassis design:

Assuming A36 steel with Y=36,000 psi, 0.9 material factor and live load factor 1.5

36,000 psi×(0.9/1.5)×89.4 in³=1,931,040 in-lb

Moment capacity=160,920 in-lb

Bending moment equation is M=PL/4

Therefore P=4M/L=160,920 in-lb×4/48 in=13,410 lbs

So the allowable midspan load would be 13,410 lbs, an amount significant enough that one may then look at reducing plate thickness, and therefore cost and weight.

Assuming the following specifications for a square tube cart frame and a generally comparable bent steel chassis:

| | | |
|---|---|---|
| Square tube cart frame: | | |
| Top plate | 24 × 56 × 3/16 | 252 in³ |
| Longitudinal tubes | 2 × 56 × 8 × 1/8 | 112 in³ |
| Lateral tubes | 3 × 24 × 8 × 1/8 | 72 in³ |
| Drive framing | 6 × 36 × 1/8 | 27 in³ |
| Steering Framing | 6 × 36 × 1/8 | 27 in³ |
| | | 490 in³ |
| Steel weighs 490 lbs/cu ft. | | |
| Therefore | 490 in³/(12³) × 490 pcf = | 139 lbs |
| Bent steel chassis: | | |
| Bent plate section | 40.8 × 55 × 1/8 | 281 in³ |
| Top plate | 26 × 58 × 3/16 | 283 in³ |
| | | 563 in³ |
| Steel weighs 490 lbs/cu ft | | |
| Therefore | 560 in³/(12³) × 490 pcf = | 159 lbs |

In the above example, the bent steel chassis is 14% heavier, but provides approximately 50 times the strength when compared to the square tube frame. As shown above, however, the bent steel thickness can be reduced while still maintaining a strength advantage over the square tube frame, and thus the weight can be brought closer to or even under the weight of the square tube frame.

While the steel plate thickness could be reduced to bring the weight down, it is also possible to use a different, lighter material for the plates. One alternative material is aluminum, which weighs 168 pcf:

168/490=0.34

which is approximately one third the weight of steel. If aluminum is selected in order to reduce overall cart weight, there would still be greater strength than a conventional tube frame. For example:

159×0.34=54 lbs

Aluminum strength in common 5052 alloy is 28,000 psi

This is 28/36=77.7% as strong as A36 steel alloy (mild steel).

Consider using 12 gauge aluminum for the bent chassis in place of 11 gauge steel:

This reduces thickness from 0.12 inch to 0.105 inch

It also changes yield strength from 36,000 psi to 28,000 psi

Overall effect on strength is 28/36×0.105/0.12=0.681

A strength at 68% still provides significant advantages over conventional steel tubing cart frames.

Further, it is well known that conventional steel tube frames are manufactured by welding the tubing components together, which adds weight, cost and manufacturing time. With a bent plate chassis (steel, aluminum or some other desirable material), the various components can be bolted together instead. While some welding may be desirable, it would be substantially reduced. In addition, square tube frames are normally made from a large number of discrete pieces, commonly 10 or more pieces, which must be welded together. By using a bent metal chassis, the number of components is reduced to two main components (the chassis and the bed member) which do not require welding.

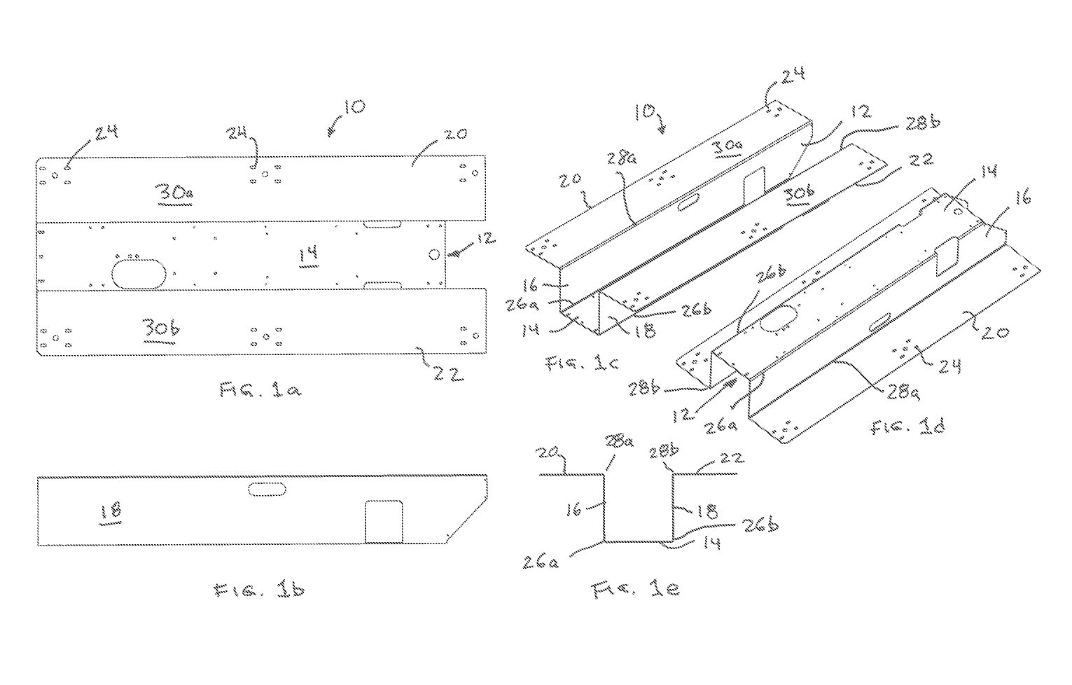

Turning to FIGS. 1a to 1e, one exemplary embodiment of a bent steel chassis is illustrated. The chassis or beam 10 provides the central support for the cart frame, and numerous cart components connect directly to the chassis 10. The chassis 10 comprises a channel-shaped member 12, which consists of a base section 14, a first side wall section 16 and a second side wall section 18. The chassis further comprises a first lateral section 20 and a second lateral section 22.

In the illustrated embodiment, the chassis 10 begins as a rigid sheet of steel (though other suitable metals or other materials could be selected by the skilled person), and various apertures necessary for later bolting together components can be formed in the rigid sheet at this point. Apertures 24 are formed in the lateral sections 20, 22 to allow bolting of a bed member 32 on top of the chassis 10, as described below.

After forming of the apertures, which would preferably be by means of punching out the apertures, the rigid sheet is then subjected to controlled bending at selected locations in a manner known to those skilled in the art of sheet metal fabrication techniques. Primary bend lines 26a,b are determined on the rigid sheet, such that when the sheet is bent at the primary bend lines 26a,b the first and second side wall sections 16, 18 thus formed are of generally equal height, with the base section 14 located between the side wall sections 16, 18. While the side wall sections 16, 18 are illustrated as being normal to the base section 14, it is also possible though not as desirable to have the side wall sections 16, 18 at an obtuse angle to the base section 14. It is believed that right angles will provide optimal strength, and support brackets (not shown) could also be used in a conventional manner between the side wall sections 16, 18 and the base section 14 to provide added strength.

To form the lateral sections 20, 22, secondary bend lines 28a,b are determined on the side wall sections 16, 18. The placement of the secondary bend lines 28a,b is determined such that when the side wall sections 16, 18 are bent at the secondary bend lines 28a,b to form the lateral sections 20, 22, the side wall sections 16, 18 are of generally equal height. The lateral sections 20, 22 are preferably horizontal and parallel to the base section 14.

While the bending of the rigid sheet along the primary bend lines 26a,b and the secondary bend lines 28a,b is described above as being separate steps in the manufacturing method, it is possible to use conventional techniques to complete both the primary and secondary bending generally simultaneously.

Once formed, the lateral sections 20, 22 provide upper surfaces 30a,b for receiving the bed member 32.

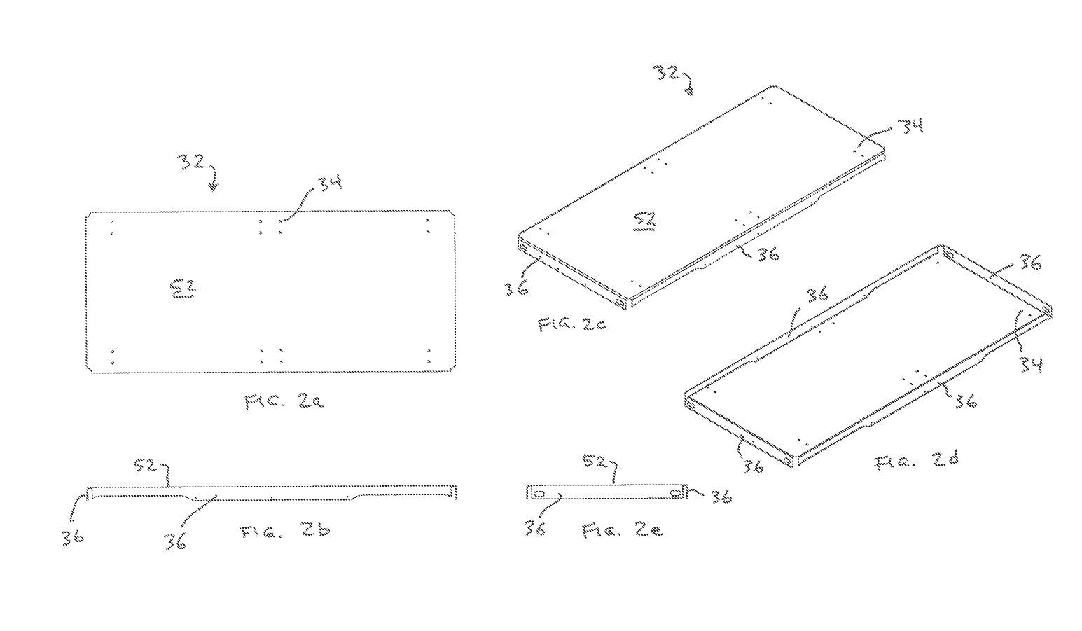

FIGS. 2a to 2e illustrate the exemplary bed member 32. Like the chassis 10, the bed member 32 begins as a rigid sheet of steel, and apertures are punched in the sheet for later use. For example, apertures 34 are provided to allow for the bolting together of the chassis 10 and the bed member 32. An upper surface 52 is intended for use as the primary load-bearing surface of the utility cart.

To enhance rigidity of the bed member 32, the four edges 36 of the bed member 32 are bent over, as shown in FIGS. 2b to 2e. Thus formed, the bed member 32 is prepared for connecting to the chassis 10.

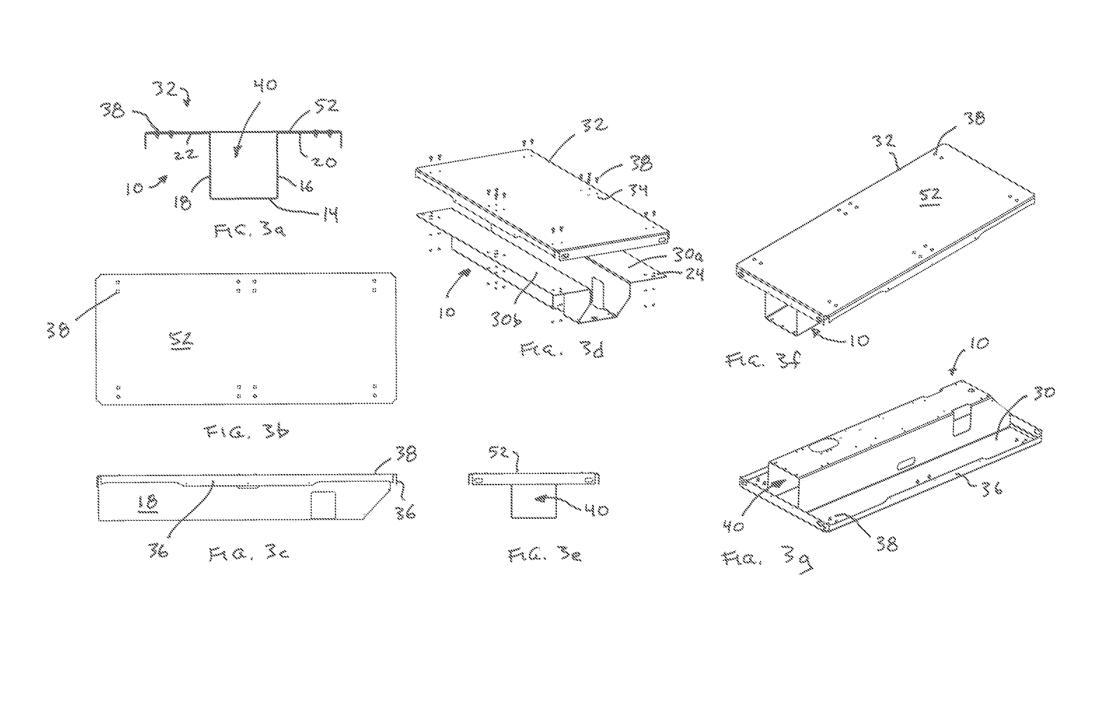

FIGS. 3a to 3g illustrate the connection of the bed member 32 to the chassis 10. FIG. 3d provides an exploded view of the bed member 32 and chassis 10, with bolts 38 aligned for insertion through the apertures 24, 34. The bed member 32 is positioned on top of the upper surfaces 30a,b of the lateral sections 20, 22 of the chassis 10, such that the apertures 24, 34 align. The bolts 38 are then passed through the apertures 24, 34 and secured by conventional means.

As can be seen in FIG. 3a, bolting the bed member 32 on top of the lateral sections 20, 22 results in an elongate four-sided channel-shaped structure, with an interior space 40 extending therethrough. This is structurally equivalent to the bent steel chassis described in the above calculations.

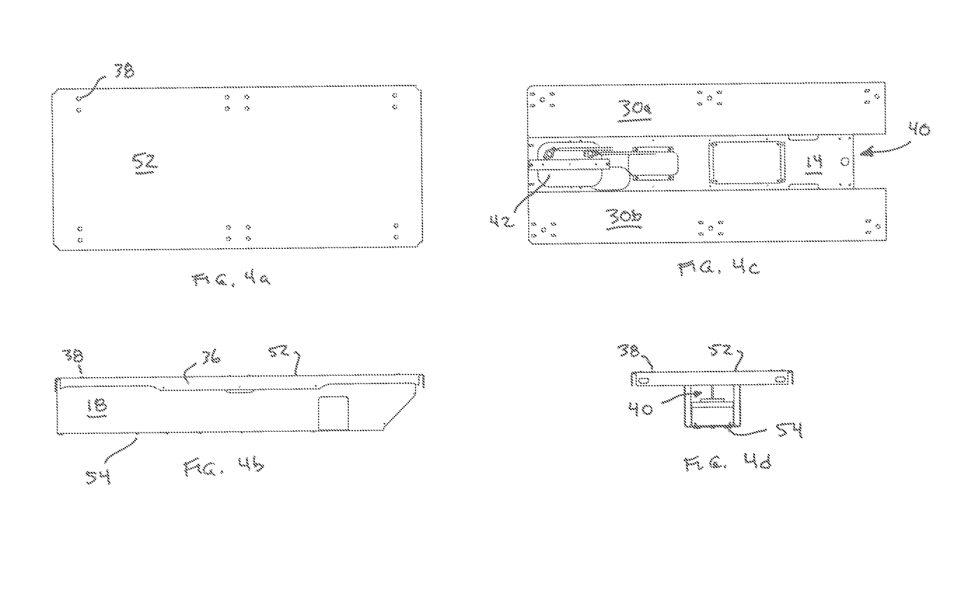

While it has been demonstrated above that this channel structure can provide strength advantages, and can be modified to provide such advantages even if the thickness and weight are reduced, a further advantage arises in the specific context of a motorized utility cart. The interior space 40 can be used to receive and retain various components required for a transport/drive assembly and steering assembly. Turning to FIGS. 4a to 4d, and shown particularly in FIGS. 4c and 4d, the interior space 40 is shown as containing various components necessary for movement and control of the utility cart. As an example, a battery 42 is shown with cables extending forwardly, but various other components and connectors could be contained within the interior space 40 provided by this novel frame design. The base section 14 is also illustrated as including apertures through which bolts 54 can extend to retain the various components within the interior space 40. The various components are thus protected within the frame interior.

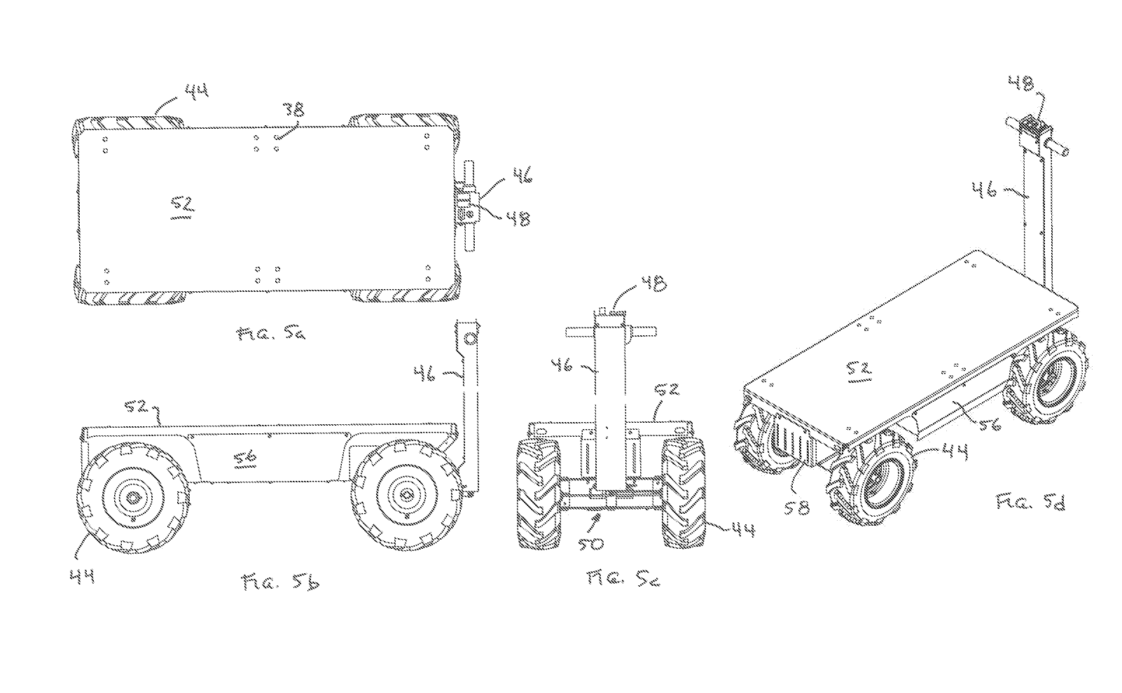

FIGS. 5a to 5d illustrate a utility cart constructed using the exemplary chassis 10 and bed member 32. As indicated above, the chassis 10 can be used to connect various components and assemblies to, such as the drive unit 50 and the axle assemblies supporting the wheels 44. Panels can also be configured for attachment to the chassis 10 or bed member 32, such as the side panel 56 which is shown as bolted to the side edge 36 of the bed member 32 and the rear panel 58 shown as bolted to both the bed member 32 and the base section 14. A steering handle assembly 46 is also illustrated in FIGS. 5a to 5d, with controls 48 on the handle for controlling the drive unit 50 by conventional means. There are various different types of transport/drive assemblies and steering assemblies in conventional use, and a skilled person would be readily able to select appropriate assemblies for use with frames in accordance with the present invention, the illustrated views of FIGS. 5a to 5d being presented merely for illustrative purposes.

Unless the context clearly requires otherwise, throughout the description and the claims:

“comprise”, “comprising”, and the like are to be construed in an inclusive sense, as opposed to an exclusive or exhaustive sense; that is to say, in the sense of “including, but not limited to”.

“connected”, “coupled”, or any variant thereof, means any connection or coupling, either direct or indirect, between two or more elements; the coupling or connection between the elements can be physical, logical, or a combination thereof.

“herein”, “above”, “below”, and words of similar import, when used to describe this specification shall refer to this specification as a whole and not to any particular portions of this specification.

“or”, in reference to a list of two or more items, covers all of the following interpretations of the word: any of the items in the list, all of the items in the list, and any combination of the items in the list.

the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of methods and apparatus have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. The scope of the claims should not be limited by the exemplary embodiment set forth in the foregoing, but should be given the broadest interpretation consistent with the specification as a whole.

1. A frame assembly for a utility cart, the assembly comprising:
a chassis comprising:
a channel-shaped member comprising:
a base section;
a first side wall section connected to the base section and extending generally upwardly therefrom; and
a second side wall section connected to the base section and extending generally upwardly therefrom, spaced from the first side wall section;
a first laterally-extending section connected to the first side wall section; and
a second laterally-extending section connected to the second side wall section; and
a bed member configured for attachment to upper surfaces of the first and second laterally-extending sections of the chassis.

2. The assembly of claim 1 wherein the chassis and the bed member are composed of steel.

3. The assembly of claim 1 wherein the chassis and the bed member are composed of aluminum.

4. The assembly of claim 1 wherein the chassis is configured for connection to a drive unit to enable movement of the utility cart across a surface.

5. The assembly of claim 1 wherein the chassis is configured for connection to a steering unit to enable directional steering of the utility cart.

6. The assembly of claim 1 wherein the base section, the first and second side wall sections, and the bed member when attached to the first and second laterally-extending sections form an open-ended, four-sided channel.

7. The assembly of claim 1 wherein the base section, the first and second side wall sections, and the bed member when attached to the first and second laterally-extending sections form an interior space sized for receipt of motorization components to enable motorization of the utility cart.

8. The assembly of claim 1 wherein the bed member is configured for attachment to the upper surfaces of the first and second laterally-extending sections by means of bolting.

9. The assembly of claim 1 wherein each of the first and second side wall sections are generally normal to the base section.

10. The assembly of claim 1 wherein each of the first and second side wall sections are at a non-right angle to the base section.

11. The assembly of claim 1 wherein the first and second laterally-extending sections are generally parallel to the base section.

12. The assembly of claim 1 wherein edges of the bed member are bent over to increase stiffness of the bed member.

13. The assembly of claim 1 further comprising at least one bracket connecting each of the first and second side wall sections to the base section.

14. The assembly of claim 1 wherein the base section, the first and second side wall sections, and the first and second laterally-extending sections are of unitary construction.

15. A frame for a utility cart, the frame comprising:
a chassis comprising:
a base section having opposed first and second edges;
first and second side wall sections connected to the first and second edges, respectively; and
first and second laterally-extending sections connected to upper edges of the first and second side wall sections, respectively;
the base section, first and second side wall sections, and first and second laterally-extending sections of unitary construction; and
a load-bearing bed member mounted on upper surfaces of the first and second laterally-extending sections;
the chassis configured for connection to transport members.

16. The frame of claim 15 wherein the chassis and the bed member are composed of steel.

17. The frame of claim 15 wherein the chassis and the bed member are composed of aluminum.

18. The frame of claim 15 wherein the transport members comprise at least two wheels to enable movement of the utility cart across a surface.

19. The frame of claim 15 wherein the chassis is configured for connection to a steering unit to enable directional steering of the utility cart.

20. The frame of claim 15 wherein the base section, the first and second side wall sections, and the bed member form an open-ended, four-sided channel.

21. The frame of claim 15 wherein the base section, the first and second side wall sections, and the bed member form an interior space sized for receipt of motorization components to enable motorization of the utility cart.

22. The frame of claim 15 wherein the bed member is mounted on the upper surfaces of the first and second laterally-extending sections by means of bolting.

23. The frame of claim 15 wherein each of the first and second side wall sections are generally normal to the base section.

24. The frame of claim 15 wherein each of the first and second side wall sections are at a non-right angle to the base section.

25. The frame of claim 15 wherein the first and second laterally-extending sections are generally parallel to the base section.

26. The frame of claim 15 wherein edges of the bed member are bent over to increase stiffness of the bed member.

27. The frame of claim 15 further comprising at least one bracket connecting each of the first and second side wall sections to the base section.

28. A utility cart comprising:
a frame assembly comprising:
a chassis comprising:
a base section having opposed first and second edges;
first and second side wall sections connected to the first and second edges, respectively; and
first and second laterally-extending sections connected to upper edges of the first and second side wall sections, respectively;
the base section, first and second side wall sections, and first and second laterally-extending sections of unitary construction;
and
a load-bearing bed member mounted on upper surfaces of the first and second laterally-extending sections;
a transport assembly operably connected to the frame assembly to enable movement of the utility cart across a surface; and
a steering assembly operably connected to the frame assembly to enable directional steering of the utility cart.

29. The utility cart of claim 28 wherein the chassis and the bed member are composed of steel.

30. The utility cart of claim 28 wherein the chassis and the bed member are composed of aluminum.

31. The utility cart of claim 28 wherein the transport assembly comprises at least two wheels to enable movement of the utility cart across a surface.

32. The utility cart of claim 31 wherein the transport assembly further comprises a drive unit to power the at least two wheels.

33. The utility cart of claim 28 wherein the steering assembly comprises a handle to enable directional steering of the utility cart.

34. The utility cart of claim 33 wherein the transport assembly comprises at least two wheels and a drive unit to power the at least two wheels, and the handle comprises manually operable controls for controlling the drive unit.

35. The utility cart of claim 28 wherein the base section, the first and second side wall sections, and the bed member form an open-ended, four-sided channel.

36. The utility cart of claim 28 wherein the base section, the first and second side wall sections, and the bed member form an interior space sized for receipt of components of the transport assembly and the steering assembly.

37. The utility cart of claim 28 wherein the bed member is mounted on the upper surfaces of the first and second laterally-extending sections by means of bolting.

38. The utility cart of claim 28 wherein each of the first and second side wall sections are generally normal to the base section.

39. The utility cart of claim 28 wherein each of the first and second side wall sections are at a non-right angle to the base section.

40. The utility cart of claim 28 wherein the first and second laterally-extending sections are generally parallel to the base section.

41. The utility cart of claim 28 wherein edges of the bed member are bent over to increase stiffness of the bed member.

42. The utility cart of claim 28 further comprising at least one bracket connecting each of the first and second side wall sections to the base section.

43. A method for manufacturing a frame for a utility cart, the method comprising the steps of:
providing a first rigid sheet;
bending the first rigid sheet at two spaced-apart primary bend lines to form first and second upwardly-extending side wall sections and a generally horizontal base section therebetween;
bending each of the first and second upwardly-extending side wall sections at secondary bend lines to form first and second outwardly-extending lateral sections, respectively;
providing a second rigid sheet; and
connecting the second rigid sheet to upper surfaces of the first and second outwardly-extending lateral sections.

44. The method of claim 43 wherein the first rigid sheet and the second rigid sheet are each composed of steel.

45. The method of claim 43 wherein the first rigid sheet and the second rigid sheet are each composed of aluminum.

46. The method of claim 43 wherein the placement of the primary bend lines is selected such that the first and second side wall sections are of generally equal height after the step of bending the first rigid sheet at the primary bend lines to form the first and second side wall sections.

47. The method of claim 43 wherein the placement of the secondary bend lines is selected such that the first and second side wall sections are of generally equal height after the step of bending the first and second side wall sections at the secondary bend lines to form the first and second lateral sections.

48. The method of claim 43 wherein the step of connecting the second rigid sheet to the upper surfaces of the first and second lateral sections forms an open-ended, four-sided channel with the base section and the first and second side wall sections.

49. The method of claim 43 wherein the step of connecting the second rigid sheet to the upper surfaces of the first and second lateral sections forms an interior space sized for receipt of motorization components to enable motorization of the utility cart.

50. The method of claim 43 wherein the second rigid sheet is connected to the upper surfaces of the first and second lateral sections by means of bolting.

51. The method of claim 50 comprising the further step after providing the first and second rigid sheets of forming apertures in the first and second rigid sheets to enable the bolting of the second rigid sheet to the first and second lateral sections.

52. The method of claim 43 wherein the step of bending the first rigid sheet at the primary bend lines forms the first and second side wall sections normal to the base section.

53. The method of claim 43 wherein the step of bending the first rigid sheet at the primary bend lines forms the first and second side wall sections at a non-right angle to the base section.

54. The method of claim 43 wherein the step of bending the first and second side wall sections at the secondary bend lines forms the first and second lateral sections generally parallel to the base section.

55. The method of claim 43 comprising the further step after providing the second rigid sheet of bending edges of the second rigid sheet to increase stiffness of the second rigid sheet.

56. The method of claim 43 comprising the further step of using at least one bracket to connect each of the first and second side wall sections to the base section.
